(19) United States
(12) Patent Application Publication
(10) Pub. No.: US 2011/0119247 A1
(43) Pub. Date: May 19, 2011

(54) METHOD AND APPARATUS FOR OBTAINING AND PROVIDING ADDITIONAL INFORMATION ABOUT WEB RESOURCES

(75) Inventor: Moon-sang Lee, Suwon-si (KR)

(73) Assignee: SAMSUNG ELECTRONICS CO., LTD., Suwon-si (KR)

(21) Appl. No.: 12/772,391

(22) Filed: May 3, 2010

(30) Foreign Application Priority Data
Nov. 18, 2009 (KR) 10-2009-0111546

(51) Int. Cl. G06F 17/30; G06F 15/16

(52) U.S. Cl. 707/709; 709/203; 707/E17.108

(57) ABSTRACT

A method of obtaining information in a client connected to a web server, the method comprising: requesting the web server for additional information about at least one web resource; and receiving the additional information about the at least one web resource from the web server. A method of providing information in a web server connected to a client, the method comprising: receiving a request for additional information about at least one web resource from the client; and transmitting the additional information about the at least one web resource to the client in response to the request.

### CROSS-REFERENCE TO RELATED PATENT APPLICATIONS

This application claims priority from Korean Patent Application No. 10-2009-0111546, filed on Nov. 18, 2009, in the Korean Intellectual Property Office, the disclosure of which is incorporated herein in its entirety by reference.

### BACKGROUND

1. Field

Exemplary embodiments relate to a method and an apparatus for obtaining additional information about web resources from a web server and a method and apparatus for providing the additional information about web resources to a client.

2. Description of the Related Art

The World Wide Web (WWW), known as the Web, is a system of interlinked hypertext documents contained on the Internet using hyperlinks. The Web can transfer data through the HyperText Transfer Protocol (HTTP) and browse web resources referring to uniform resource locators (URLs).

### SUMMARY

It is an aspect of an exemplary embodiments to provide a method and an apparatus for obtaining additional information about web resources from a web server and to provide a method and an apparatus for providing the additional information about web resources to a client.

According to an aspect of the exemplary embodiment, there is provided a method of obtaining information in a client connected to a web server, the method including: requesting the web server for additional information about at least one web resource; and receiving the additional information about the at least one web resource from the web server.

The requesting the web server for the additional information may include: extracting link information of the at least one web resource from a web page; and selectively requesting the web server for the additional information about the at least one web resource based on the extracted link information.

The requesting the web server for the additional information may include requesting the web server for the additional information about the at least one web resource included in a web page downloaded via web crawling.

The client may be a web search server.

The method may further include selectively requesting the web server for the at least one web resource based on the received additional information.

The requesting of the web server for the additional information may include: generating an additional information request field and inserting the generated additional information request field in a header of a HyperText Transfer Protocol (HTTP) request message; and transferring the HTTP request message to the web server.

According to another aspect of the exemplary embodiment, there is provided a method of providing information in a web server connected to a client, the method including: receiving a request for additional information about at least one web resource from the client; and transmitting the additional information about the at least one web resource or a uniform resource locator (URL) that provides a location of the additional information to the client in response to the request.

The transmitting the additional information may include: inserting the additional information or the URL in a header of a HTTP response message; and transmitting the HTTP response message to the client.

The transmitting the additional information may include: inserting the additional information in a body of the HTTP response message; and transmitting the HTTP response message to the client.

The method may further include if the at least one web resource based on the additional information are requested from the client, transmitting the requested at least one web resource to the client.

According to another aspect of the exemplary embodiment, there is provided an apparatus for obtaining information from a web server, the apparatus including: an additional information request unit which requests the web server for additional information about at least one web resource; and an additional information receiving unit which receives the additional information about the at least one web resource from the web server.

According to another aspect of the exemplary embodiment, there is provided an apparatus for providing a client with information, the apparatus including: a receiving unit which receives a request for additional information about at least one web resource from the client; and a transmitting unit which transmits the additional information about the at least one web resource or a uniform resource locator (URL) that provides a location of the additional information to the client in response to the request.

According to yet another aspect, a method of obtaining information from a web server is provided. The method may include transmitting a request for content from the web server, where the request includes a request for metadata for the requested content, receiving the requested metadata, and determining which part of the content to request based on the metadata.

### BRIEF DESCRIPTION OF THE DRAWINGS

The above and/or other aspects of the exemplary embodiments will become more apparent by describing in detail thereof with reference to the attached drawings in which:

FIG. 1 is a flowchart illustrating a method of obtaining additional information from a web server according to an exemplary embodiment;

FIG. 2 illustrates a web search server and a web server according to an exemplary embodiment;

FIG. 3 illustrates a HyperText Transfer Protocol (HTTP) request message according to an exemplary embodiment;

FIG. 4 illustrates additional information about an image according to an exemplary embodiment;

FIG. 5 is a flowchart illustrating a method of providing additional information about at least one web resource from a web server to a client according to an exemplary embodiment;

FIG. 6 illustrates a HTTP response message according to an exemplary embodiment;

FIG. 7 illustrates a HTTP response message according to another exemplary embodiment;

FIG. 8 illustrates a HTTP response message according to another exemplary embodiment;

FIG. 9 illustrates a HTTP response message according to another exemplary embodiment; and

FIG. 10 is a block diagram of an apparatus for obtaining additional information about web resources in a client connected to a web server and an apparatus for providing the additional information about the web resources in the web server connected to the client according to an exemplary embodiment.

### DETAILED DESCRIPTION OF EXEMPLARY EMBODIMENTS

Hereinafter, the exemplary embodiments will be described in detail with reference to the attached drawings.

FIG. 1 is a flowchart illustrating a method of obtaining additional information from a web server according to an exemplary embodiment. Referring to FIG. 1, in operation 110, a client requests the web server to provide additional information about at least one web resource. Web resources, such as HyperText Markup Language (HTML), image data, audio data, motion picture data, etc., can be obtained using a uniform resource locator (URL) over the Web. In an exemplary embodiment, the client directly requests the web server that provides the web resources existing in web pages for the additional information about the web resources. The client may request the web server to provide the additional information about the web resources before downloading the web pages from the web server. The client may request the web server for the additional information about all the web resources existing in the web pages and may request the web server for additional information about specific web resources.

In an exemplary embodiment, the client extracts link information of the at least one web resource from the web page. That is, a web page may reference various web resources such as other web pages, music files, audio files, movie files, etc. The client may extract the link information which provides a reference to the resource and may analyze the extracted link information and request for the additional information about the at least one web resource according to the result of analysis. For example, if the link information about the at least one web resource indicates information about a plurality of music source files, a client user may request the web server for additional information about all the music source files or some of them.

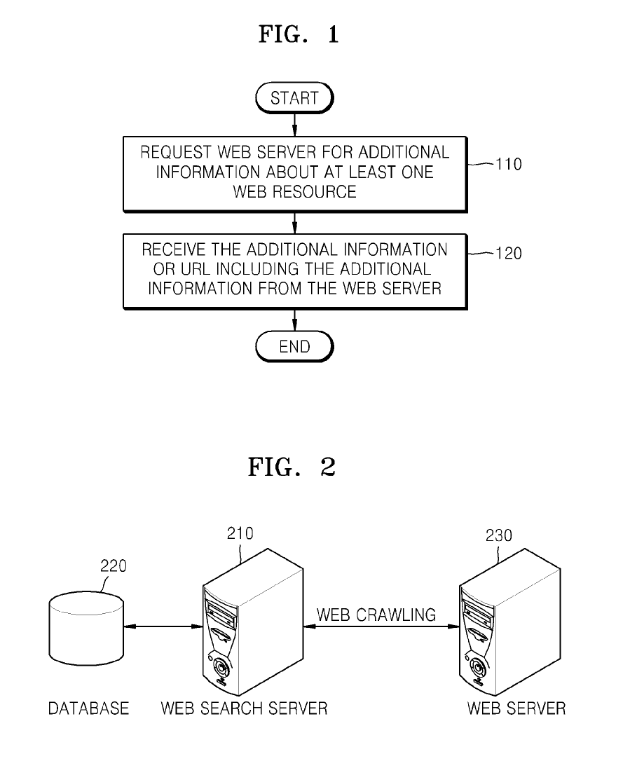

In an exemplary embodiment, if the client is a web search engine, i.e. a web search server, the web search server may request the web server providing the web resource for additional information, i.e. metadata, about the predetermined web resource during web crawling. FIG. 2 illustrates a web search server 210 and a web server 230 according to an exemplary embodiment. Referring to FIG. 2, the web search server 210 crawls a web document of the web server 230 using a search engine and stores the crawled web document in a database 220. The web search server 210 may request additional information about a web resource, such as an image, and store a necessary web resource only in the database 220 during web crawling.

In an exemplary embodiment, the client requests the web server for the additional information using the HyperText Transfer Protocol (HTTP) that is an application layer protocol of the Web. To be more specific, the client extends the HTTP, defines an additional information request field in a HTTP request message, and transfers the HTTP request message to the web server. The HTTP request message includes a request line and a header line. The HTTP request message is described in the RFC 2616 that is the HTTP protocol standard incorporated herein by reference and thus the description thereof will not be repeated here. In an exemplary embodiment, the client defines an additional information request message in the header line of the HTTP request message and transfers the HTTP request message to the web server. The web server transfers the corresponding web resource to the client according to a value of the additional information request field. For example, the client generates a field in the format of “‘Request-Meta: Exclusive|Inclusive|None” in the header line and defines that the header line “‘Request-Meta: Exclusive” requests only additional information about a web resource, the header line “‘Request-Meta: Inclusive” requests the web resource and the additional information about the web resource, and the header line “‘Request-Meta: None” requests no additional information about the web resource.

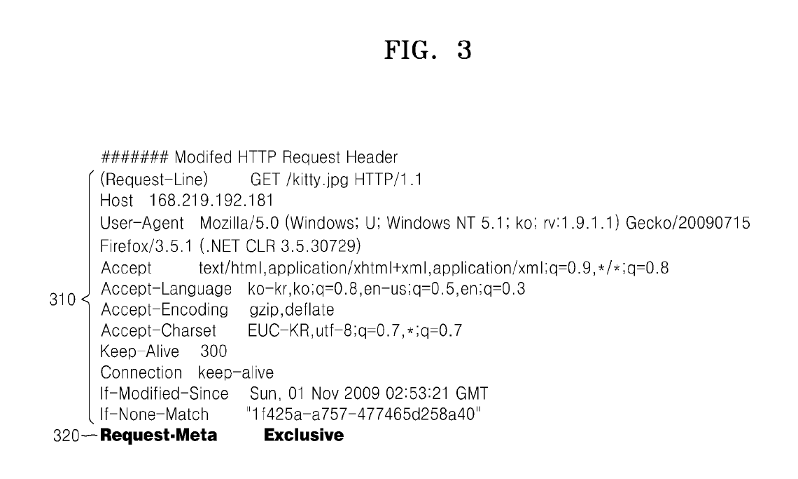

FIG. 3 illustrates a HTTP request message according to an exemplary embodiment. Referring to FIG. 3, the reference numeral 310 denotes a request line and a header line, and the reference numeral 320 denotes a newly defined header line that requests additional information about a web resource. The header line “Request-Meta: Exclusive” requests a web server for the additional information about the web resource.

Referring back to FIG. 1, in operation 120, the client may receive the additional information from the web server or may receive a URL including the additional information from the web server. The client may selectively request the at least one web resource from the web server based on the received additional information. In more detail, in an exemplary embodiment, the client may use the additional information received from the web server to request a necessary web resource again or to perform a predetermined process with regard to web resources existing in a current web page.

For example, there is heavy web traffic due to many motion pictures contained in a web site, such as Youtube (www.youtube.com). Therefore, the client may request a web server of Youtube for additional information, receive the additional information, and receive a web page containing a motion picture, a necessary web resource according to the received additional information. In more detail, the client user may use the received additional information to receive necessary content only without having to download all contents during the Web access, so that the client can prevent unnecessary web traffic from occurring. The web search server 210 may use the additional information about the web resources to receive web pages containing necessary web resources from the web server 230 and store the received web pages in the database 220 described with reference to FIG. 2.

In an exemplary embodiment, the additional information is metadata indicating general information about the web resource. The additional information may vary and thus the present invention is not limited thereto. For example, Exif in the format of an exchange image file further includes metadata that provides information about pictures. The metadata may be an example of the additional information. The additional information includes information about a place taken by a camera with a GPS receiver embedded therein and a camera manufacturer, a camera model, a rotational direction, date and time, color space, a focal distance, flash, an ISO speed, iris, a shutter speed, and the like.

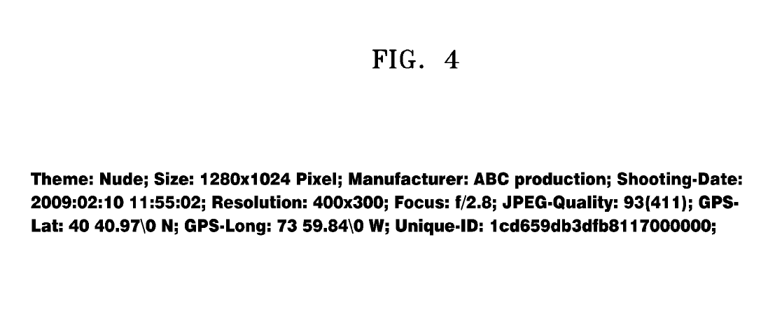

FIG. 4 illustrates additional information about an image according to an exemplary embodiment. Referring to FIG. 4, the additional information about the image includes a theme, size, name of a manufacturer, shooting-date, resolution, focus, JPEG-quality, GPS information (GPS-Lat and GPS-Long), a unique ID, and the like. However, the items included in the additional information of FIG. 4 are exemplary and the present invention is not limited thereto. The client user may set a web resource, i.e. the image, not to be displayed on a web page and may prevent the image from being downloaded in the client during the Web access according to the item “Theme: nude”, for example, included in the received additional information in order to prevent juveniles or children from seeing the image.

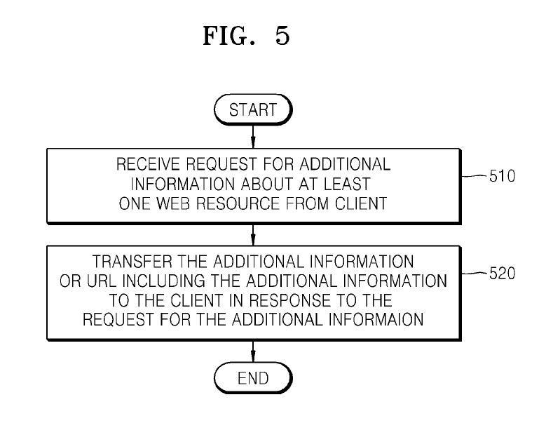

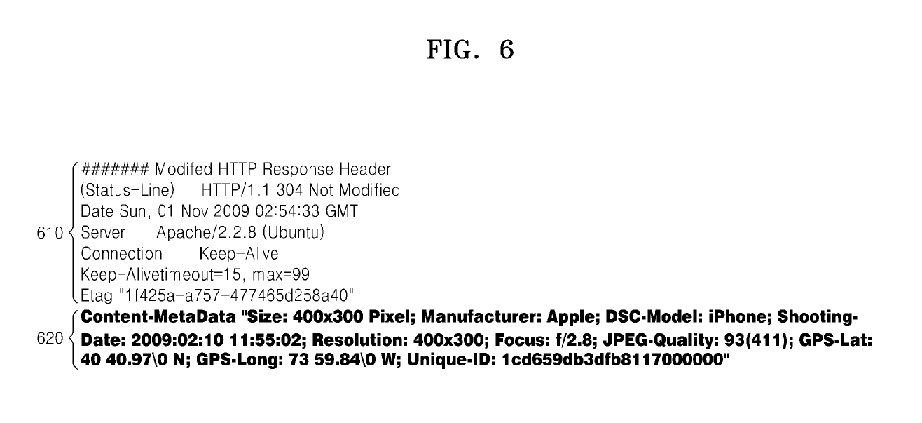

FIG. 5 is a flowchart illustrating a method of providing additional information about at least one web resource from a web server to a client according to an exemplary embodiment. Referring to FIG. 5, in operation 510, the web server receives a request for the additional information about the at least one web resource from the client.

In operation 520, the web server transfers the requested additional information about the at least one web resource to the client. In an exemplary embodiment, the web server transfers the additional information about the at least one web resource to the client using the HTTP that is an application layer protocol of the Web. In more detail, the web server defines an additional information transfer field in a HTTP response message and transfers the HTTP response message to the client. The HTTP response message includes a status line, a header line, and a body. The HTTP response message is described in the RFC 2616 that is the HTTP protocol standard incorporated herein by reference and thus the description thereof will not be repeated here. In an exemplary embodiment, the web server inserts the additional information in the header line of the HTTP response message and transfers the HTTP response message to the client. The web server may insert the additional information in the format of the XML, such as a quoted string, or may insert a URL in which the additional information is stored in the header line of the HTTP response message.

FIG. 6 illustrates a HTTP response message according to an exemplary embodiment. Referring to FIG. 6, a field is used to transfer additional information about a web resource in the format of a quoted string to a header line of the HTTP response message. Reference numeral 610 denotes a status line and a header line, and reference numeral 620 denotes a newly defined header line that provides additional information about the web resource. A quoted string included in quotation marks is additional information about the web resource. That is, the additional information about the web resource is “‘Size: 400×300 Pixel; Manufacturer: Apple; DSC-Model: iPhone; Shooting-Date: 2009:02:10 11:55:02; Resolution: 400×300; Focus: f/2.8; JPEG-Quality: 93(411); GPS-Lat: 40 40.97\0 N; GPS-Long: 73 59.84\0 W; Unique-ID: 1cd659db3dfb 8117000000”.

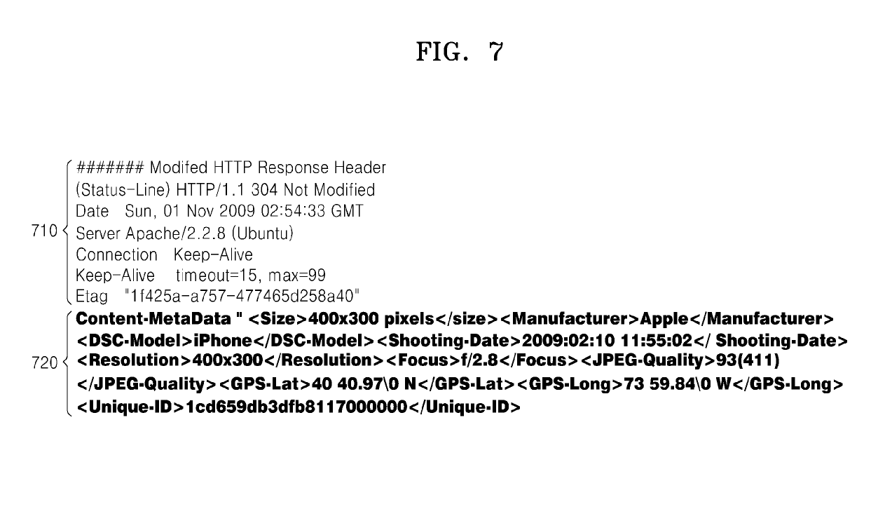

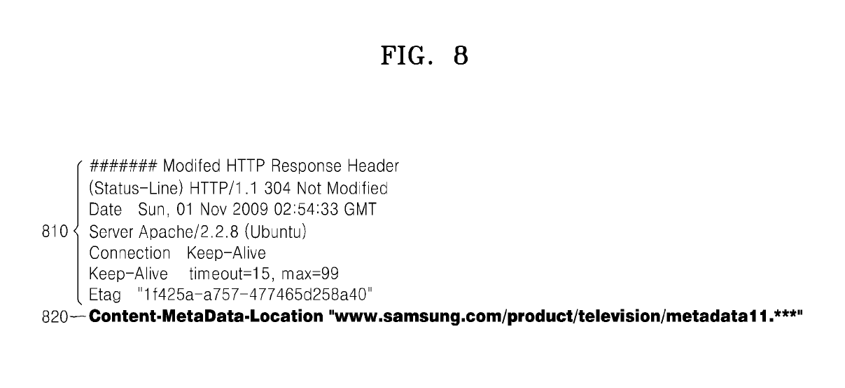

FIG. 7 illustrates a HTTP response message according to another exemplary embodiment. FIG. 7 illustrates a field used to transfer additional information about web resources in the format of the XML to a header line of a HTTP response message according to an exemplary embodiment. Referring to FIG. 7, reference numeral 710 denotes a status line and a header line, and reference numeral 720 denotes a newly defined header line that provides the additional information about the web resource. “Content-metadata” is a field used to provide the additional information about the web resource. A part in the format of the XML in quotation marks is the additional information about the web resources. That is, the size property of the additional information about web resources is “<Size>400×300 pixels</size>”, the manufacturer property thereof is “<Manufacturer>Apple</Manufacturer>”, the model property thereof is “<DSC-Model>iPhone</DSC-Model>”, the shooting date property thereof is “<Shooting-Date>2009:02:10 11:55:02</Shooting-Date>”, the resolution property thereof is “<Resolution>400>300</Resolution>”, the focus property thereof is “<Focus>f/2.8</Focus>”, the JPEG-quality property thereof is “<JPEG-Quality>93(411)</JPEG-Quality>”, the GPS information property thereof is “<GPS-Lat>40 40.97\0 N</GPS-Lat>” and “<GPS-Long>73 59.84\0 W</GPS-Long>”, and the unique ID property thereof is “<Unique-ID>1cd659db3dfb8117000000</Unique-ID>”.

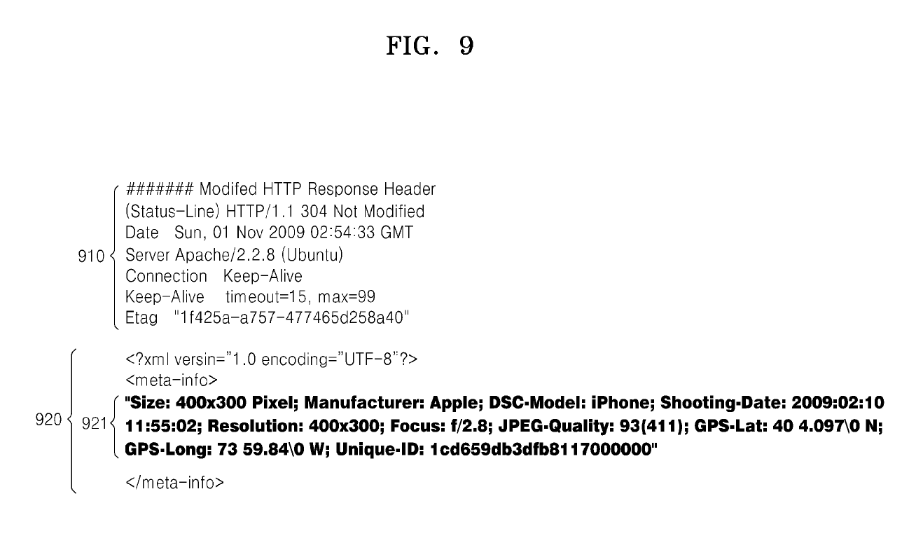

FIG. 8 illustrates a HTTP response message according to another exemplary embodiment. Referring to FIG. 8, a field is used to transfer additional information about a web resource in the format of a quoted string to a header line of the HTTP response message. Reference numeral 810 denotes a status line and a header line, and reference numeral 820 denotes a newly defined header line that provides additional information about the web resource. “Content-Metadata_Location” is a field used to provide the additional information about the web resource. The part “‘www.samsung.com/product/television/metadata11.***” indicates a URL in which the additional information is stored.

In an exemplary embodiment, the web server may insert the additional information in the body of the HTTP response message and transfers the HTTP response message to the client. The web server may insert the additional information in the format of a quoted string in the body of the HTTP response message and transfer the HTTP response message to the client. The web server may insert the additional information in the format of the XML in the body of the HTTP response message. The web server may insert the URL in which the additional information is stored in the body of the HTTP response message and transfer the HTTP response message to the client.

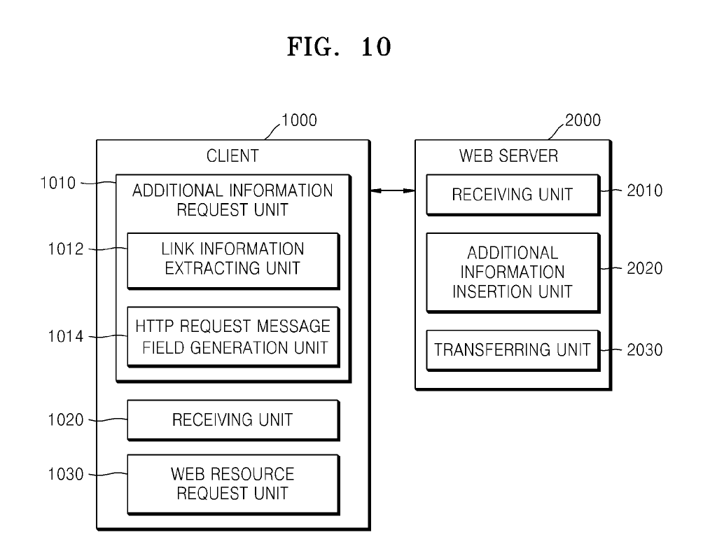

FIG. 9 illustrates a HTTP response message according to another exemplary embodiment. Referring to FIG. 9, a field is used to insert additional information about a web resource in the format of a quoted string in a body of the HTTP response message as opposed to the header described in exemplary embodiments above. Reference numeral 910 denotes a status line and a header line, and reference numeral 920 denotes a part of the body. Reference numeral 921 denotes the additional information about the web resource inserted in the body of the HTTP response message.

FIG. 10 is a block diagram of an apparatus for obtaining additional information about web resources from a client 1000 that may be executing on the obtaining apparatus connected to a web server 2000 and an apparatus for providing the additional information about the web resources in the web server 2000 that may be running in the providing apparatus connected to the client 1000 according to an exemplary embodiment. The obtaining and providing apparatuses may include at least a processor executing the client and server, respectively, and a memory storing the client and a server, respectively. As an alternative embodiment, the client and the server may be executing in same apparatus.

Referring to FIG. 10, the client 1000 for requesting and obtaining the additional information about the web resources may include an additional information request unit 1010, a receiving unit 1020, and a web resource request unit 1030. The additional information request unit 1010 may include a link information extraction unit 1012 and a HTTP request message field generation unit 1014. The web server 2000 for providing the additional information about the web resources includes a receiving unit 2010, an additional information insertion unit 2020, and a transferring unit 2030.

The additional information request unit 1010 requests the web server 2000 for additional information about at least one web resource. The additional information request unit 1010 directly requests the web server 2000 that provides web resources existing in a web page for the additional information about the at least one web resource. The additional information request unit 1010 may request only the additional information about the at least one web resource before downloading the web page from the web server 2000. The additional information request unit 1010 may request additional information about all the web resources existing in the web page or additional information about some of them.

In an exemplary embodiment, the link information extraction unit 1012 extracts link information of the at least one web resource from the web page. The additional information request unit 1010 may analyze the extracted link information and request the web server 2000 for the additional information according to the result of analysis. For example, if the link information about the at least one web resources indicates information about a plurality of music source files, a user of the client 1000 may request the web server 2000 for additional information about a predetermined one of the music source files.

In an exemplary embodiment, if the client 1000 is a web search engine, i.e. a web search server, the additional information request unit 1010 may request the web server 2000 for additional information, i.e. metadata, about a predetermined web resource during web crawling. Referring to FIG. 2, the web search server 210 which may correspond to the client 1000 crawls a web document of the web server 230 using a search engine and stores the crawled web document in the database 220. The web search server 210 may request additional information about a web resource, such as an image, and store a necessary web resource only in the database 220 during web crawling.

In an exemplary embodiment, the client 1000 requests the web server 2000 for the additional information using the HTTP that is an application layer protocol of the Web. To be more specific, the HTTP request message filed generation unit 1014 extends the HTTP and defines an additional information request field in a HTTP request message. Thereafter, the additional information request unit 1010 transfers the HTTP request message to the web server 2000. The HTTP request message includes a request line and a header line. The HTTP request message is described in the RFC 2616 that is the HTTP protocol standard and thus the description thereof will not be repeated here. In an exemplary embodiment, the additional information request unit 1010 transfers the HTTP request message including the additional information request message defined by the HTTP request message field generation unit 1014 to the web server 2000. The web server 2000 transfers the corresponding web resource to the client 1000 according to a value of the additional information request field. For example, the HTTP request message field generation unit 1014 generates a field in the format of “‘Request-Meta: Exclusive|Inclusive|None” in the header line and defines that the header line “‘Request-Meta: Exclusive” requests only additional information about a web resource, the header line “‘Request-Meta: Inclusive” requests the web resource and the additional information about the web resource, and the header line “‘Request-Meta: None” requests no additional information about the web resource.

The receiving unit 1020 receives from the web server 2000 the additional information from the web server 2000 or receives a URL which provides a link to the additional information. In more detail, in an exemplary embodiment, the web resource request unit 1030 uses the additional information received from the web server 2000 to request a necessary web resource again or to perform a predetermined process with regard to web resources existing in a current web page.

For example, there is heavy web traffic when the client 1000 accesses a web page containing many motion pictures with large capacity. Therefore, the additional information request unit 1010 may request the web server 2000 for additional information only. The receiving unit 1020 may receive the additional information and receive a web page containing a necessary web resource according to the received additional information. In more detail, the user of the client 1000 may use the received additional information to only receive the necessary content without having to download all contents during the Web access, so that the client 1000 can prevent unnecessary web traffic from occurring during the web access.

In an exemplary embodiment, the additional information is metadata indicating general information about the web resource.

The receiving unit 2010 of the web server 2000 receives a request for the additional information about the at least one web resource from the client 1000.

The transferring unit 2030 transfers the requested additional information about the at least one web resource to the client. In an exemplary embodiment, the web server 2000 transfers the additional information about the at least one web resource or a URL including the additional information to the client 2000 using the HTTP that is an application layer protocol of the Web. In more detail, the additional information insertion unit 2020 defines an additional information transfer field in a HTTP response message, inserts the additional information in the additional information transfer field, and transfers the additional information transfer field to the client 1000. The HTTP response message includes a status line, a header line, and a body. The HTTP response message is described in the RFC 2616 that is the HTTP protocol standard and thus the description thereof will not be repeated here. In the an exemplary embodiment, the additional information insertion unit 2020 inserts the additional information in the header line of the HTTP response message and transfers the HTTP response message to the client 1000. For example, the additional information insertion unit 2020 may insert the additional information in the format of the XML or in the format of a quoted string in the header line of the HTTP response message. Alternatively, the additional information insertion unit 2020 may insert the URL to the additional information in the header line of the HTTP response message and may transfer the HTTP response message to the client 1000 through the transferring unit 2030.

In an exemplary embodiment, the web server 2000 may insert the additional information in the body of the HTTP response message and transfers the HTTP response message to the client 1000. The additional information insertion unit 2020 may insert the additional information in the format of the XML or in the format of the quoted string in the header line of the HTTP response message. The transferring unit 2030 may transfer the HTTP response message to the client 1000. The additional information insertion unit 2020 may insert the URL in which the additional information is stored in the body of the HTTP response message. The transferring unit 2030 may transfer the HTTP response message to the client 1000.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices. Alternatively, the invention can also be embodied on carrier waves (such as data transmission through the Internet). The computer readable recording medium can also be distributed over network coupled computer systems so that the computer readable code is stored and executed in a distributed fashion. Also, functional programs, code and code segments for accomplishing the exemplary embodiments can be easily construed by programmer skilled in the art to which the present invention pertains.

Although a few exemplary embodiments have been particularly shown and described, it will be understood by those of ordinary skill in the art that various changes in form and details may be made therein without departing from the spirit and scope of the invention as defined by the appended claims.

What is claimed is:

1. A method of obtaining information in a client connected to a web server, the method comprising:
requesting the web server for additional information about at least one web resource; and
receiving the additional information about the at least one web resource from the web server.

2. The method of claim 1, wherein the requesting the web server for the additional information comprises:
extracting link information of the at least one web resource from a web page; and
selectively requesting the web server for the additional information about the at least one web resource based on the extracted link information.

3. The method of claim 1, wherein the requesting the web server for the additional information comprises: requesting the web server for the additional information about the at least one web resource included in a web page downloaded via web crawling.

4. The method of claim 3, wherein the client is a web search server.

5. The method of claim 1, further comprising: selectively requesting the web server for the at least one web resource based on the received additional information.

6. The method of claim 1, wherein the requesting the web server for the additional information comprises:
generating an additional information request field;
adding the generated additional information request field to a header of a HyperText Transfer Protocol (HTTP) request message; and
transmitting the HTTP request message to the web server.

7. A method of providing information in a web server connected to a client, the method comprising:
receiving a request for additional information about at least one web resource from the client; and
transmitting the additional information about the at least one web resource or a uniform resource locator (URL) that provides a location of the additional information to the client in response to the request.

8. The method of claim 7, wherein the transmitting the additional information or the URL comprises:
inserting the additional information or the URL in a header of a HTTP response message; and
transmitting the HTTP response message to the client.

9. The method of claim 7, wherein the transmitting the additional information or the URL comprises:
inserting the additional information in a body of a HTTP response message; and
transmitting the HTTP response message to the client.

10. The method of claim 7, further comprising: if the at least one web resource is requested by the client based on the additional information, transmitting the at least one requested web resource to the client.

11. An apparatus for obtaining information from a web server, the apparatus comprising:
an additional information request unit which requests the web server for additional information about at least one web resource; and
an additional information receiving unit which receives the additional information about the at least one web resource from the web server.

12. The apparatus of claim 11, wherein the additional information request unit comprises: a link information extracting unit which extracts link information for the at least one web resource from a web page,
wherein the apparatus selectively requests the web server for the additional information about the at least one web resource based on the extracted link information.

13. The apparatus of claim 11, wherein the additional information request unit requests the web server for the additional information about the at least one web resource provided in a web page downloaded via web crawling.

14. The apparatus of claim 11, further comprising: a web resource request unit which selectively requests the web server for the at least one web resource based on the received additional information.

15. The apparatus of claim 11, wherein the additional information request unit comprises: a HTTP request message field generation unit which generates an additional information request field for a header of a HTTP request message,
wherein the apparatus transmits the HTTP request message to the web server.

16. An apparatus for providing a client with information, the apparatus comprising:
a receiving unit which receives a request for additional information about at least one web resource from the client; and
a transmitting unit which transmits the additional information about the at least one web resource or a uniform resource locator (URL) pointing a location of the additional information to the client in response to the request.

17. The apparatus of claim 16, further comprising: an additional information insertion unit which inserts the additional information or the URL in a header of a HTTP response message in response to a HTTP request message received in the receiving unit,
wherein the transmitting unit transmits the HTTP response message to the client.

18. The apparatus of claim 16, wherein the additional information insertion unit inserts the additional information in a body of the HTTP response message in response to the HTTP request message received in the receiving unit,
wherein the transmitting unit transmits the HTTP response message to the client.

19. The apparatus of claim 16, wherein the receiving unit receives a request from the client for the at least one web resource based on the additional information, and the transmitting unit transmits the at least one requested web resource to the client.

20. A computer readable recording medium storing a program for executing a method of obtaining information in a client connected to a web server, the method comprising:
requesting the web server for additional information about at least one web resource; and
receiving the additional information about the at least one web resource from the web server.
